(19) United States
(12) Patent Application Publication
(10) Pub. No.: US 2009/0096259 A1
(43) Pub. Date: Apr. 16, 2009

(54) ERGONOMIC SUPPORT STRUCTURE MADE OF COMPOSITE MATERIAL FOR HUMAN BODY PARTS AND METHOD OF MANUFACTURING SAME

(75) Inventor: Stefano Segato, Vicenza (IT)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Selle Royal S.P.A., Pozzoleone (IT)

(21) Appl. No.: 11/814,941

(22) PCT Filed: Jan. 27, 2006
(86) PCT No.: PCT/IB06/00144

§ 371 Date: Mar. 11, 2008

(30) Foreign Application Priority Data
Jan. 28, 2005 (IT) VI2005A000025

(51) Int. Cl. B62J 1/00; B29C 43/18

(52) U.S. Cl. 297/214; 264/271.1

(57) ABSTRACT

An ergonomic support structure of composite material, particularly for supporting parts of the human body. The structure comprises a main body (2) with a viscoelastic insert (3) permanently anchored thereto. The main body (2) is made of composite material having a reinforcement member (4) selected from the group of carbon fibers, glass fibers or the like, and having a polymer matrix (5). The viscoelastic insert (3) is a polymethane gel. The main body (2) and the viscoelastic insert (3) are covered by a transparent polymeric cover layer (7). A process for making the above structure in a mold.

### FIELD OF THE INVENTION

This invention finds application in the field of mechanical structures made of special materials, and particularly relates to a support structure of composite material.

Furthermore, the invention relates to a process for making the above structure.

### BACKGROUND OF THE INVENTION

Cover pads of foam material are known to be used to enhance comfort and ergonomic benefit in rigid bodies coming in contact, during use, with parts of human bodies, such as seats of composite material for vehicles, bicycle saddles or the like.

Nevertheless, this solution is unacceptably uncomfortable, inconvenient, and aesthetically prejudicial for the parts designed to support the pad, which are wholly covered thereby.

In an attempt to obviate the above drawbacks, gel inserts are being increasingly used at the areas subjected to the highest pressure by users, to provide comfort where this is most needed. Gel is preferable as compared with foam, due to its viscoelastic behavior, which improves distribution of interface pressure in response to static stresses, and improved vibration damping in response to cyclic dynamic stresses, as well as a high elastic after-effect in response to impulsive stresses.

U.S. Pat. No. 6,050,964 discloses an elastic fabric structure, having thermoplastic gel thereon, to form an ergonomic support base for the parts covered thereby.

One drawback of this prior art structure is that, although it is undoubtedly comfortable and resilient, the fabric sheath that encapsulates the gel tends to be easily cut and ruptured, with gel tending to leak therefrom. Furthermore, the gel insert, which would be pleasant to the sight, is covered thereby.

Other technical arrangements equivalent to the above are known from U.S. Pat. No. 5,904,396, EP-A2-1382520, U.S. Pat. No. 5,330,249.

U.S. Pat. No. 6,450,572 discloses a saddle having a rigid support frame overlying a double cushion composed of more rigid foam and more resilient foam, on which gel portions are formed, which are designed to undergo changes in shape when they contact moving parts of a user.

While this solution is comfortable and not exposed to undesired damaging, it has the drawback of incorporating a cushion, which makes the structure heavier and unpleasant to the view.

The problem of direct coupling of one composite material to gel inserts has not been solved to date.

### SUMMARY OF THE INVENTION

The object of this invention is to overcome the above drawbacks, by providing an ergonomic support structure that is highly efficient and relatively cost-effective.

A particular object is to provide an ergonomic support structure that can be customized, i.e. adapted to the body of any user.

A further object of the invention is to provide an ergonomic support structure that is pleasing to the sight.

Another object of the invention is to provide an ergonomic support structure having a light weight and a high strength.

Yet another object of the invention is to provide a practical and easily repeatable process for making the ergonomic support structure of the invention.

These objects, as well as other objects that will be more apparent hereafter, are fulfilled by a support structure of composite material according to claim 1, which comprises a main body with a viscoelastic insert permanently anchored thereto, wherein the main body has at least one reinforcement member made of a material selected from those having a relatively low density and a relatively high mechanical strength, said reinforcement member being associated to at least one polymer matrix for permanently anchoring said at least one insert.

Thanks to this particular configuration, the ergonomic structure of the invention is highly comfortable, adapted to a huge number applications, such as the fabrication of bicycle saddles, chairs, car seats or the like.

Furthermore, the structure of the invention allows to avoid the use of cushions, that were used as comfort elements in prior art structures. This allows to make structures that are both comfortable and of a very light weight.

Also, direct coupling between the composite and the viscoelastic materials provides an assembly that is highly pleasing to the sight, a non-negligible advantage in the field of sports and leisure, which is highly influenced by fashion and aesthetics.

Advantageously, this at least one insert may be placed over said reinforcement member to define a free contact surface for the user susceptible of controlled deformation.

Thanks to this feature, the structure of the invention meets the needs of various users, regardless of specific conformations of the part of the body in contact with the structure. The natural ergonomic quality of the viscoelastic material allows the structure to be easily and comfortable adapted to anyone.

Suitably, the structure of the invention may have a polymeric cover layer, placed above said at least one insert and the top surface of said polymer matrix.

Thanks to this feature, the structure is highly pleasing to the touch and safe, as it protects users from any rupture of the reinforcement member which might otherwise release dangerous splinters and injure users.

According to another aspect of the invention there is provided a process for making an ergonomic support structure like the one disclosed above, according to claim 9, which includes the steps of: providing at least one reinforcement member made of a material selected from those having a relatively low density and a relatively high mechanical strength; providing a mold with an inner cavity of a predetermined shape corresponding to the external configuration of a main body of a support structure; opening said mold and laying said at least one reinforcement member thereon; placing at least one insert of a viscoelastic material on said at least one reinforcement member; sealing said mold and heating it to a predetermined operating temperature; cooling said mold to a predetermined final temperature and opening said mold and removing the finished support structure.

Thanks to the above process, the support structure of the invention may be formed in a practical and easily repeatable manner.

### BRIEF DESCRIPTION OF THE DRAWINGS

Further features and advantages of the invention will be more apparent from the detailed description of a preferred, non-exclusive embodiment of a structure according to the invention, which is described as a non-limiting example with reference to the annexed drawings, in which:

FIG. 1 is an axonometric view of a support structure according to the invention;

FIG. 2 is an axonometric view of a detail of FIG. 1;

FIG. 3 is a sectioned view of the structure of the invention, as taken along a plane III-III;

FIG. 4 is another sectioned view of the structure of the invention, as taken along a plane IV-IV;

FIG. 5 shows a flowchart of a process for making the support structure of the invention.

### DETAILED DESCRIPTION OF A PREFERRED EMBODIMENT

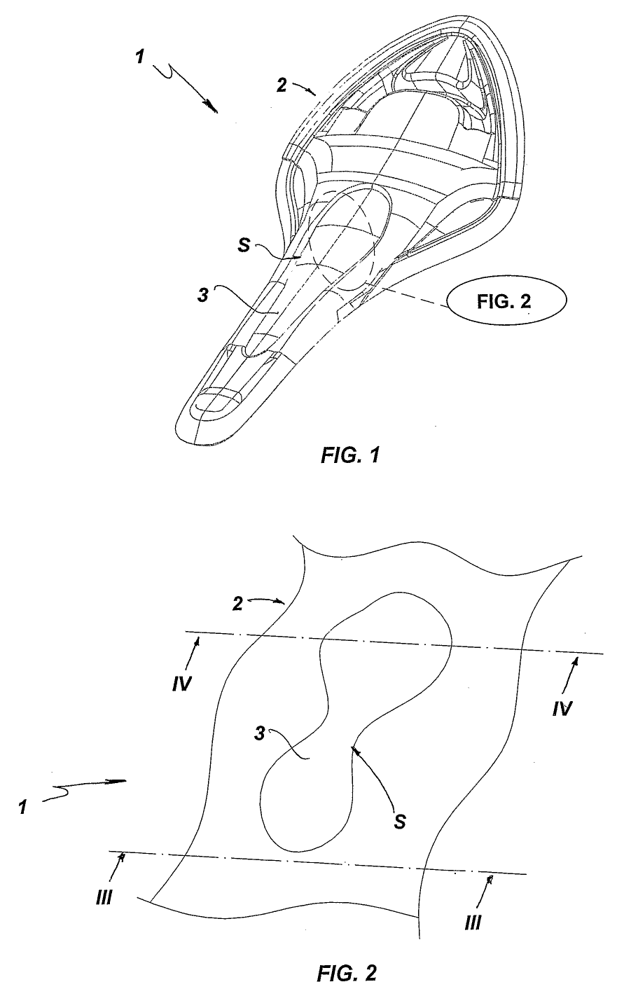

Referring to the above figures, the structure of the invention, generally designated by numeral 1, may be, for instance, a part of a car seat, or a chair or a bicycle saddle, as shown in FIG. 1.

Typically, the structure 1 comprises a main body 2, with a viscoelastic insert 3, preferably made of polyurethane gel, anchored thereto. The insert defines a free contact surface S for the user and, thanks to its natural ergonomic properties, it may be freely placed at the contact areas between the user and the structure 1, e.g. the ischial or prostatic regions, in the case of a bicycle saddle.

The body 2 is made of a composite material which is known to be essentially composed of a reinforcement member 4 associated to a polymer matrix 5, which may be of the thermoplastic or thermosetting type.

Particularly, the member 4 has a low density and a high mechanical strength, i.e. a high resistance to compressive and/or tensile and/or bending and/or torsional and/or shearing stresses. Furthermore, as is known, the matrix 5 is essentially composed of one or more thermoplastic or thermosetting resins, possibly reinforced.

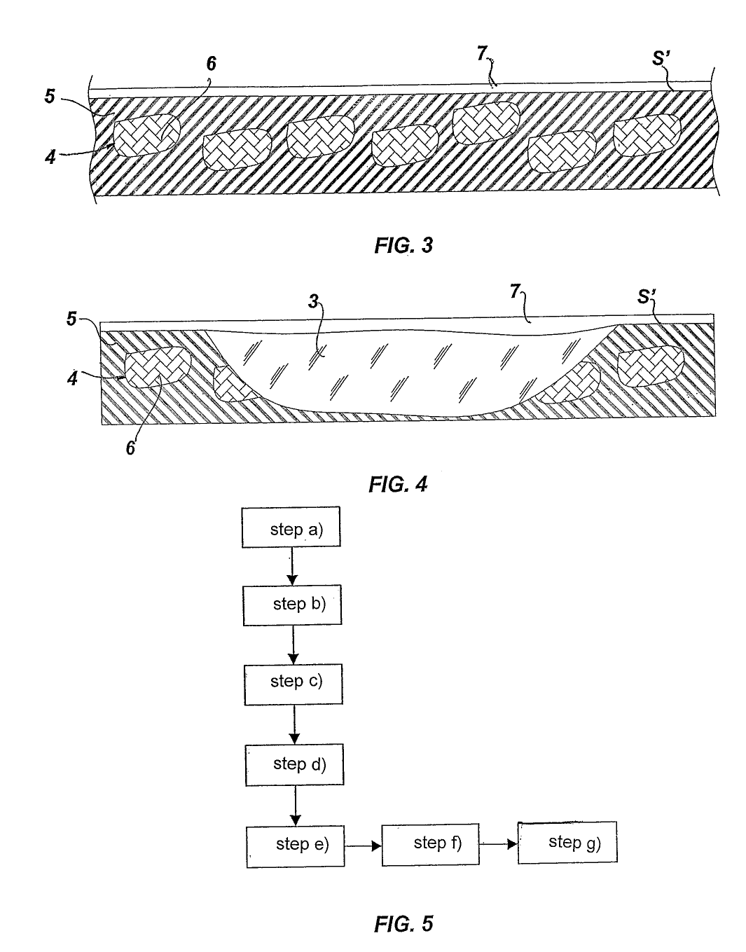

According to the invention, the reinforcement member 4 may include a fibrous membrane 6, e.g. made of carbon, glass fibers or the like, associated to a matrix 5, in which the membrane 6 may be embedded, as particularly shown in FIG. 3.

In such configuration, the insert 3 will be permanently anchored to the body 2 by chemical and/or mechanical bonds, which will be formed during the structure making process that, as set out below, includes a heating step, during which the polymer matrix 5 is polymerized. This provides a monolithic structure 1, in which the inserts 3 are formed of one piece with the body 2, as particularly shown in FIG. 4.

Conveniently, both the reinforcement member 4 and the matrix 5 may comprise reinforcing fibers, particles or nanoparticles.

As mentioned above, the structure 1 may have a polymeric cover layer 7, having protective functions.

Advantageously, the layer 7 may be transparent, so that the aesthetically pleasing connection between the composite material of the body 2 and the gel of the insert 3 is visible.

A process for making the structure 1 includes the following steps.

The first step is step a), in which the reinforcement member 4 is provided in the form of a sheet, including, as mentioned above, the membrane 6 of carbon, glass fibers or the like.

Suitably, the membrane 6 may be preimpregnated with the resin 5, or be in the form of a dry sheet.

In the next step b) a mold is provided, having the shape of the main body 2. If the above membrane 6 is not preimpregnated, the mold may have one or more apertures for injection of the polymer matrix 5 therein, which will be added to the dry membrane 6 at a later time.

Then, in step c), the mold is opened and the reinforcement member 4 is laid thereon, and in the next step d) one or more inserts 3 are further placed thereon.

As is known, the gel of the latter may have various densities. If it is in liquid form, it may be poured into the mold. In this case, the mold will suitably have one or more specially shaped carved housings, for receiving the gel.

Advantageously, the cover layer 7 may be placed in the mold to protect the membrane 6 and the inserts 3, thereby providing the above mentioned advantages.

In the next step e), the mold is sealed and heated to a predetermined operating temperature, possibly after injection of the matrix 5 if, as suggested above, the membrane 6 has been laid in the form of a dry sheet. This temperature may be of 20° C. to 300° C., and preferably of about 120° C. The temperature will be typically close to the glass transition temperature of the matrix 5. In this step, chemical and/or mechanical bonds will be formed, thereby providing a monolithic assembly of the body 2, the inserts 3 and possibly the membrane 6.

After a step f), in which the mold is cooled to a predetermined final temperature, of 18° C. to 50° C., and preferably of about 20° C., the final step g) will follow, during which the mold is opened, and the finished support structure 1 is removed.

The above disclosure clearly shows that the structure of the invention fulfills the proposed objects and particularly meets the requirement of providing a highly comfortable and customizable support structure.

By directly coupling the composite of the body 2 and the gel of the insert 3, a very comfortable structure is obtained, which is capable of fitting the anthropometric conformation of any user whatever.

The structure of the invention is susceptible to a number of changes and variants, within the inventive concept disclosed in the appended claims. All the details thereof may be replaced by other technically equivalent parts, and the materials may vary depending on different needs, without departure from the scope of the invention.

While the structure has been described with particular reference to the accompanying figures, the numerals referred to in the disclosure and claims are only used for the sake of a better intelligibility of the invention and shall not be intended to limit the claimed scope in any manner.

1. An ergonomic support structure of composite material, said structure comprising a main body having at least one reinforcement member having a predetermined resistance to compressive or shearing stresses, said reinforcement member comprising a fibrous membrane which is associated to and embedded in at least one polymer matrix, and further comprising at least one viscoelastic insert anchored in said main body and placed over said reinforcement member to define a free contact surface (S) for the user, said contact surface being susceptible to controlled deformation.

2. Support structure as claimed in claim 1, wherein said fibrous membrane is selected from the group consisting of carbon fibers, glass fibers, and combinations thereof.

3. Support structure as claimed in claim 1, wherein the structure comprises a polymeric cover layer placed above said at least one insert and the top surface (S′) of said polymer matrix.

4. Support structure as claimed in claim 3, characterized wherein said cover layer is of the transparent type.

5. Support structure as claimed in claim 1, wherein said viscoelastic material is a gel material.

6. Support structure as claimed in claim 5, wherein said gel comprises a polyurethane gel.

7. A process for making the support structure of claim 1, comprising the steps of:
a) providing at least one reinforcement member made of a material having a relatively low density and a relatively high mechanical resistance to compressive and shearing stresses;
b) providing a mold with an inner cavity of a predetermined shape corresponding to the external configuration of the main body of the support structure;
c) opening said mold and depositing at least one reinforcement member therein;
d) placing the at least one viscoelastic insert on said at least one reinforcement member;
e) sealing said mold and heating it to a predetermined operating temperature;
f) cooling said mold to a predetermined final temperature; and
g) opening said mold and removing the finishing support structure therefrom.

8. A process as claimed in claim 7, wherein said at least one reinforcement layer is impregnated with a polymer matrix.

9. A process as claimed in claim 7, further comprising placing a polymeric cover layer above said at least one insert and the top surface (S′) of said reinforcement member.

10. A process as claimed in claim 7, wherein said mold has at least one aperture for injection of a thermoplastic or thermosetting resin therein.

11. A process as claimed in claim 7, wherein said mold has at least one carved housing for receiving said at least one viscoelastic insert.

12. A process as claimed in claim 7, wherein said predetermined operating temperature is of 20° C. to 300° C.

13. A process as claimed in claim 7, wherein said predetermined final temperature is of 18° C. to 50° C.

14. A process as claimed in claim 7, wherein said predetermined operating temperature is about 120° C.

15. A process as claimed in claim 7, wherein said predetermined final temperature is about 20° C.
